(19) United States
(12) Patent Application Publication
(10) Pub. No.: US 2015/0007915 A1
(43) Pub. Date: Jan. 8, 2015

(54) Tire Cavity Air Flow Features

(71) Applicant: Bridgestone Americas Tire Operations, LLC, Nashville, TN (US)

(72) Inventors: Brian D. Steenwyk, Uniontown, OH (US); Stephen M. Vossberg, Uniontown, OH (US)

(73) Assignee: Bridgestone Americas Tire Operations, LLC, Nashville, TN (US)

(21) Appl. No.: 14/381,336

(22) PCT Filed: Mar. 12, 2013
(86) PCT No.: PCT/US13/30495

§ 371 Date: Aug. 27, 2014

Related U.S. Application Data
(60) Provisional application No. 61/611,305, filed on Mar. 15, 2012.

(51) Int. Cl. B60C 23/18

(52) U.S. Cl. CPC B60C 23/18
USPC 152/153

(57) ABSTRACT

Provided is a pneumatic tire comprising an annular interior surface having a circumference, and an air flow feature. The annular interior surface is adapted for engagement with a wheel, defines an interior surface circumferential direction along the annular interior surface in the direction of the circumference, defines an interior surface meridinal direction tangent to the annular interior surface and perpendicular to the direction of the circumference, and defines an interior surface normal direction mutually perpendicular to both other directions. The air flow feature is engaged with the annular interior surface, adapted to direct a flow of inflation air into a non-circumferential direction, and comprises an air flow feature surface comprising a portion that extends in the interior surface normal direction and the interior surface meridinal direction, and either extends more than 2 millimeters in the interior surface normal direction, or extends in the interior surface circumferential direction.

### TECHNICAL FIELD

The present subject matter relates generally to a tire. More, specifically, the present subject matter relates to a tire or a tire-wheel system comprising one or more air flow features.

### BACKGROUND

As a tire operates, it rolls along a surface. As the tire rolls along the surface, the tire material undergoes repeated cycles of strain. The repeated cycles of strain generate heat through hysteresis. That is, operation of a tire tends to generate heat. Typically, a tire is operated in such a way that it will heat up during use, until it reaches a substantially steady state at which time the temperature of the tire is such that the heat generated is equal to the heat output less the heat input.

The rate of heat generation, that is, the heat generated per unit time, is a function of multiple variables including, but not generally limited to, the speed, load, and tire material properties. The heat generated per unit time is generally a positive function of speed; that is, all other variables being equal, higher speeds generate more heat per unit time.

The heat output from the tire takes place through heat transfer mechanisms of conduction, convection, and radiation. The rate of heat output from the tire is generally a positive function of the temperature of the tire; all other variables being equal the higher the temperature of the tire, the greater the heat output per unit time.

Heat generated during operation of the tire will tend to increase the temperature of the tire until a substantially steady state operating temperature is reached at which steady state temperature the heat output rate is substantially equal to the sum of the rate of heat generation plus the rate of heat input.

Temperature is a variable affecting tire life, especially high speed tire life. Tire durability increases if the tire is cooler. It is possible to reduce the steady state operating temperature by increasing heat output rate by improving heat transfer through one or more of conduction, convection, and radiation.

It remains desirable to develop tire air flow features to promote convective heat exchange.

### SUMMARY

Provided is a pneumatic tire that may comprise an annular interior surface having a circumference, and an air flow feature. The annular interior surface may be adapted for engagement with a wheel, may define an interior surface circumferential direction along the annular interior surface in the direction of the circumference, may define an interior surface meridinal direction tangent to the annular interior surface and perpendicular to the direction of the circumference, and may define an interior surface normal direction mutually perpendicular to both other directions. The air flow feature may be engaged with the annular interior surface, adapted to direct a flow of inflation air into a non-circumferential direction, and may comprise an air flow feature surface comprising a portion that extends in the interior surface normal direction and the interior surface meridinal direction, and may either extend more than 2 millimeters in the interior surface normal direction, or may extend in the interior surface circumferential direction.

Further provided is a tire-wheel system comprising a wheel comprising a rim portion, a pneumatic tire adapted for inflation with inflation air, and one or more air flow features. The rim portion may comprise an annular exterior surface and may be adapted for engagement with a pneumatic tire. The annular exterior surface may have a circumference defining a wheel circumferential direction. The pneumatic tire may comprise an axis of operational rotation defining a tire axial direction, an annular interior surface, and a tire radial direction mutually perpendicular to both the tire axial direction and the tire circumferential direction. The annular interior surface may be adapted for engagement with the rim portion of the wheel and may have a circumference defining a tire circumferential direction. The one or more air flow features may be engaged with the annular interior surface of the pneumatic tire, or the annular exterior surface of the wheel. The one or more air flow features may comprise an air flow feature surface adapted to direct a flow of the inflation air into a direction having a component along the tire radial direction and the tire axial direction. The air flow feature surface may comprise at least a portion thereof that extends in the tire radial direction and the tire axial direction, and either extends more than 2 millimeters in the radial direction, or extends in tire circumferential direction.

Further provided is a pneumatic tire adapted for inflation with inflation air. The pneumatic tire may comprise an annular interior surface and a plurality of air flow features. The annular interior surface may have a circumference, may be adapted for engagement with a wheel, may define an interior surface circumferential direction along the annular interior surface in the direction of the circumference, may define an interior surface meridinal direction tangent to the annular interior surface and perpendicular to the direction of the circumference, and may define an interior surface normal direction mutually perpendicular both to the interior surface circumferential direction and to the interior surface meridinal direction. Each of said plurality of air flow features may be an integrally formed component of said annular interior surface. The plurality of air flow features may comprise at least three air flow features spaced circumferentially around the annular interior surface. Each of said plurality of air flow features may be adapted to direct a flow of inflation air into a non-circumferential direction. At least one of said plurality of air flow features may comprise an air flow feature surface that may comprise at least a portion thereof that extends in the interior surface normal direction, the interior surface meridinal direction, and the interior surface circumferential direction. At least one of said plurality of air flow features may comprise an air flow feature surface that extends more than 2 millimeters in the interior surface normal direction, wherein at least one of said plurality of air flow features may comprise an air flow feature surface having a plane of tangency at angle with respect to the interior surface meridinal direction of 10 degrees or more.

### BRIEF DESCRIPTION OF THE DRAWINGS

FIG. 1 is a side view of one embodiment of a tire model showing computational fluid dynamics results.

FIG. 2 is a front view of the crown region of one embodiment of a tire showing computational fluid dynamics results.

FIG. 3 is a front view of the footprint region of one embodiment of a tire showing computational fluid dynamics results.

FIG. 4 is a front sectional view of one embodiment of a tire-wheel system.

FIG. 5 is a graph showing velocity at the bottom of a tire on the vertical axis and radial distance on the horizontal axis.

FIG. 6 is a graph showing velocity at the bottom of a tire relative to straight translation with the tire on the vertical axis and radial distance on the horizontal axis.

FIG. 7 is a graph showing velocity at the bottom of a tire relative to rigid rotation with the wheel on the vertical axis and radial distance on the horizontal axis.

FIG. 8 is a graph showing velocity at the top of a tire on the vertical axis and radial distance on the horizontal axis.

FIG. 9 is a graph showing velocity at the top of a tire relative to rigid rotation with the tire on the vertical axis and radial distance on the horizontal axis.

FIG. 10 is a graph showing velocity at the top of a tire relative to rigid rotation with a wheel on the vertical axis and radial distance on the horizontal axis.

FIG. 11 is a schematic side view of one embodiment of a tire showing air cavity flow velocity profiles at the crown region and at the footprint region.

FIG. 12 is front sectional view of the footprint region of one embodiment of a tire.

FIG. 13 is view normal to the roadway of an interior region of one embodiment of a tire as it passes through the footprint.

FIG. 14 is view normal to the roadway of an interior region of another embodiment of a tire as it passes through the footprint.

FIG. 15 is view normal to the roadway of an interior region of another embodiment of a tire as it passes through the footprint.

### DETAILED DESCRIPTION

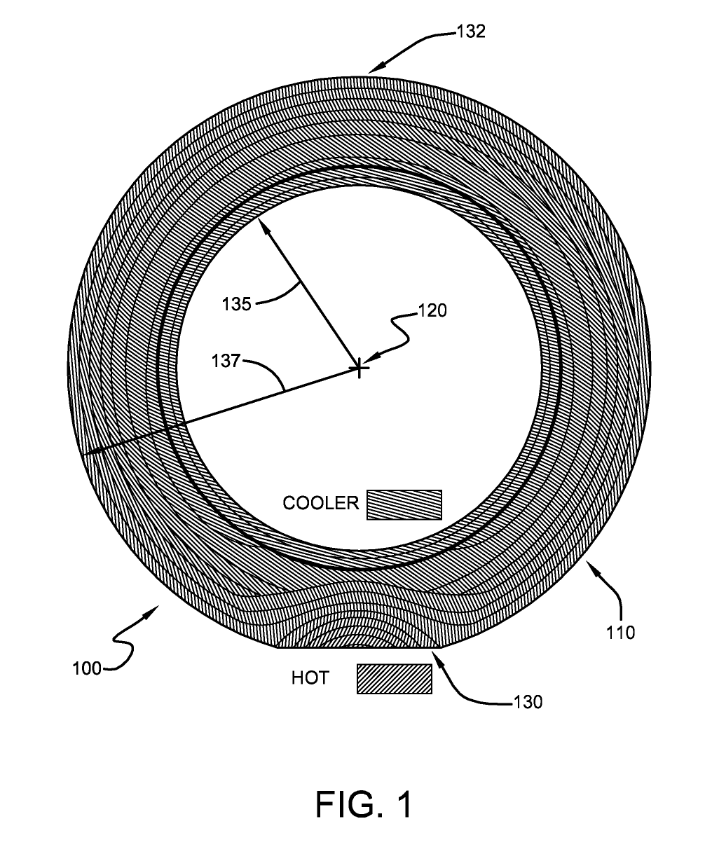

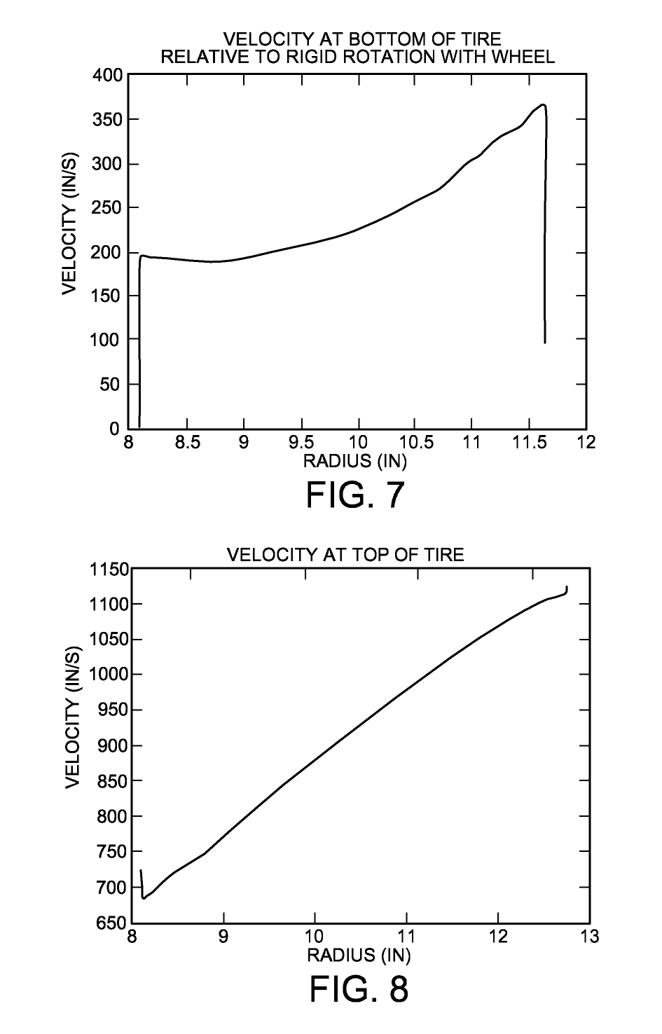

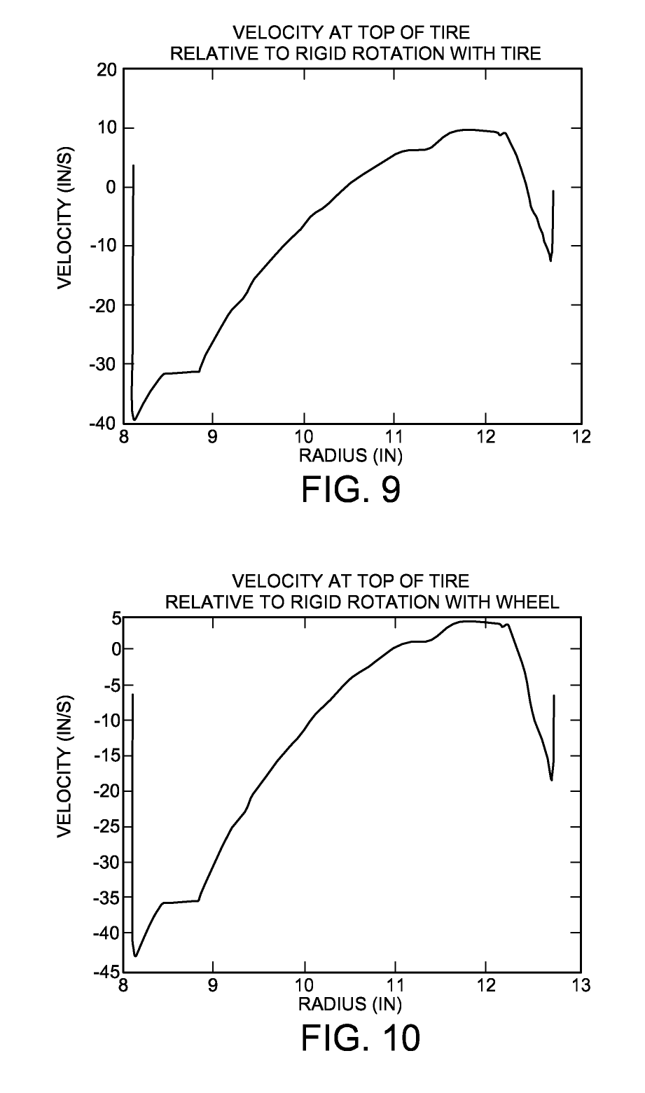

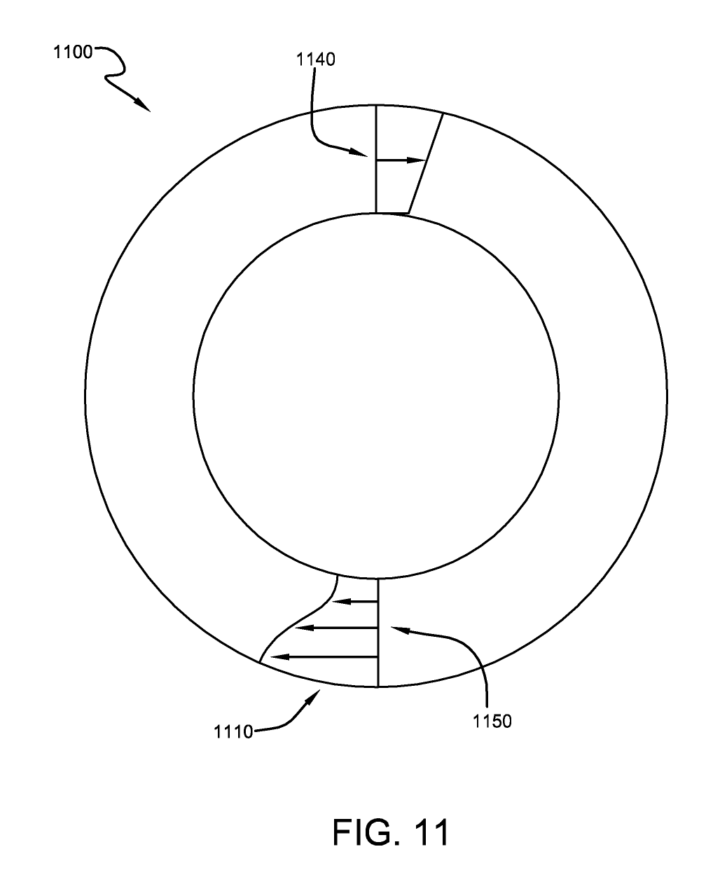

Reference will be made to the drawings, FIGS. 1-15, wherein the showings are only for purposes of illustrating certain embodiments of a tire cavity air flow feature, a tire comprising a tire cavity air flow feature, and tire-wheel system comprising a tire cavity air flow feature.

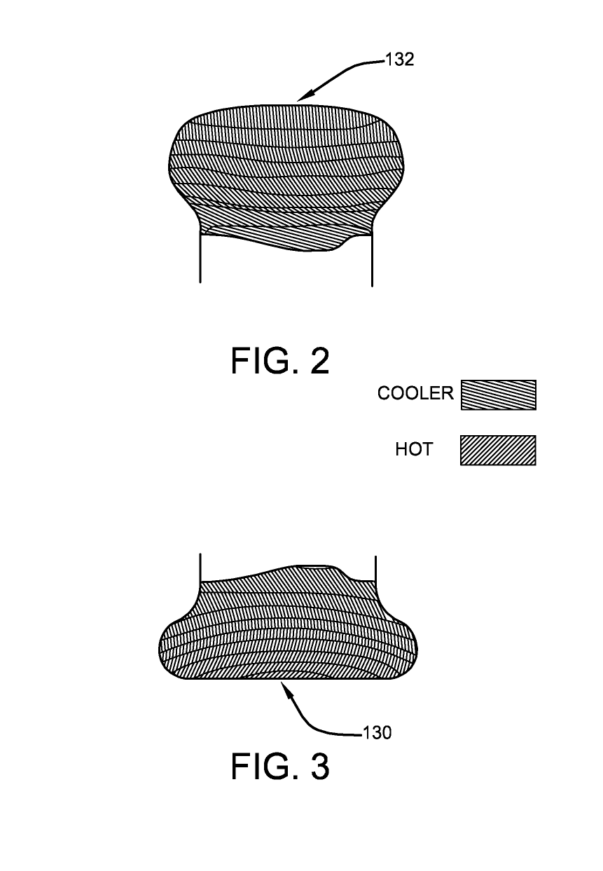

FIG. 1 shows a side view of one embodiment of a tire model 100 showing graphic computational fluid dynamics results 110. FIGS. 2 and 3 show these same computational fluid dynamics results 110 from frontal viewpoints proximate to the crown 132, and proximate to the footprint region 130, respectively. The computational fluid dynamics results 110 show velocity of an air flow 1320 of the inflation air 431 throughout the tire model 100. As used herein unless otherwise noted, air is used in the general sense to refer to a gas used for inflation of a pneumatic tire and is not limited to atmospheric air, or shop air, or dry air, but rather may comprise other gases; air may comprise atmospheric air, shop air, dry air, nitrogen, argon, other gases, or mixtures thereof. Similarly, air flow may refer to flow of any of the gases that air may comprise. Referring again to FIGS. 1-3, the computational fluid dynamics results 110 are based on assumptions of a P215/55R17 passenger size tire rolling along a roadway, in this case a 10 foot diameter drum, at 65 mph under a 1146 lbf load and inflated with shop air as inflation air 431 to 30.5 psi cold and 33.4 psi hot. While the specific results shown in FIGS. 1-3 may depend on the above inputs, the general trends and findings herein are not specific to any particular tire, tire size, speed, load, inflation gas, roadway or inflation pressure. In FIGS. 1-3, the calculated flow velocity at any given point based on the above inputs, is primarily a function of two variables: 1) radial distance from the axis of rotation 120 of the tire model 100; 2) proximity to the footprint region 130. Addressing the flow velocity as a function of radial distance from the axis of rotation 120 of the tire model 100 first, in general, flow closer to the axis of rotation 120 of the tire model 100 is slower than the flow further from the axis of rotation 120. In regions distal from the footprint region 130, the flow along inner radius 135, is slightly less than the speed of the wheel exterior surface which is 715 inches per second. In regions distal from the footprint region 130, the flow along outer radius 137, is slightly less than the speed of the tire interior surface which is 1142 inches per second. In general, in regions distal from the footprint region 130, the flow velocity can be substantially described as a positive function of radial position. Addressing the flow velocity as a function of proximity to the footprint region 130, in the region proximate to the footprint region 130 the flow at any given radial position is substantially faster than flow at the same radial position in regions distal from the footprint region 130. The reasons for this will be addressed more fully herebelow. In general, in regions proximate to the footprint region 130, the flow velocity can be substantially fully described as a positive function of radial position and proximity to the center of the footprint.

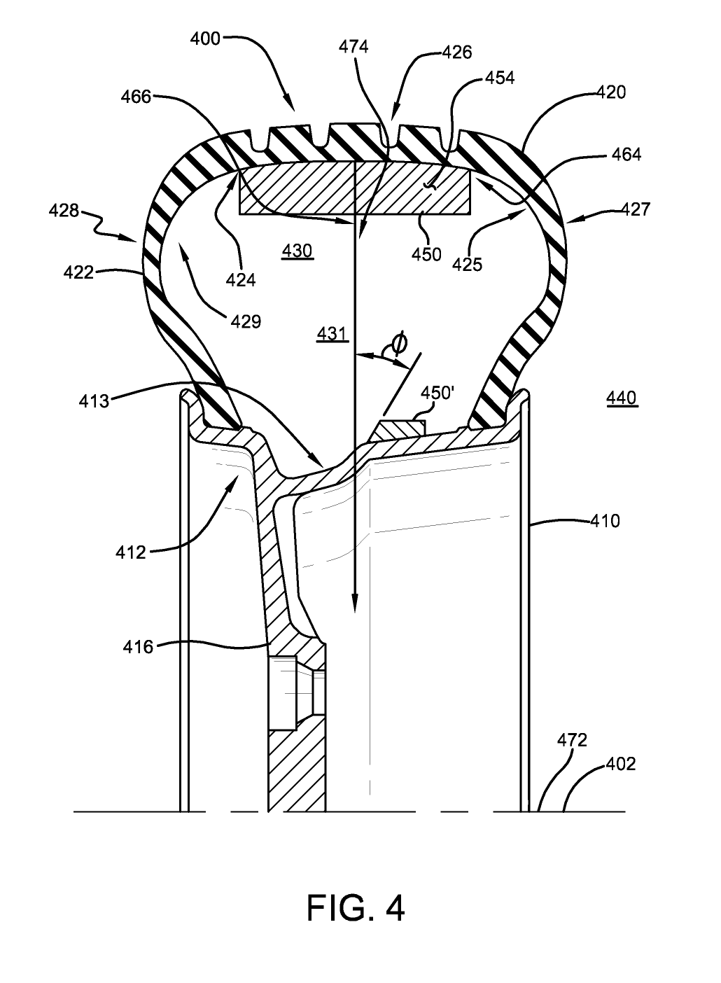

The tire model 100 shown in FIGS. 1-3 may represent the performance of air in a tire-wheel system. Referring now to FIG. 4, shown is an embodiment of tire cavity air flow feature 450, 450′ in conjunction with an associated tire-wheel system 400. The tire wheel system 400 comprises a wheel 410 and a tire 420. Wheel 410 may comprise any of various kinds wheels designed to have a tire 420 mounted thereabout. In the embodiments shown in FIG. 4, wheel 410 comprises a rim portion 412 adapted for engagement with tire 420, such as, without limitation, pneumatic tire 422, and a plate portion 416 adapted for engagement with an associated vehicle (not shown). The rim portion 412 comprises an annular exterior surface, that is, wheel rim surface 413, extending around axis 402 in a closed loop and therefore has a wheel circumference that defines a wheel circumferential direction. While the rim portion 412 is shown varying in radius from axis 402 such that the wheel circumference varies with axial position, the circumferential direction taken at any given axial position is the same as that at any other axial position. In the embodiments shown in FIG. 4, tire 420 is a pneumatic vehicle tire 422. In other embodiments, tire 420 may comprise a run-flat tire or another sort of tire. A pneumatic tire 422 is a tire 420 that is adapted for inflation with inflation air 431. In the embodiment shown in FIG. 4, the tire 420 and the wheel 410 together define an internal cavity 430. The internal cavity 430 is substantially isolated from the surrounding environment 440 by the tire 420 and the wheel 410 and may contain air or be inflated with inflation air 431 to some pressure above that of the surrounding environment 440. In the embodiment shown in FIG. 4, pneumatic vehicle tire 422 comprises an axis of operational rotation 402 that defines and coincides with tire axial direction 472. Pneumatic vehicle tire 422 comprises an annular interior surface 424 that extends around axis 472 in a closed loop and therefore has a circumference that defines a tire circumferential direction. Pneumatic vehicle tire 422 further comprises a tire radial direction 474 that is mutually perpendicular to both the tire axial direction 472 and the tire circumferential direction. An internal cavity 430 may be defined by a set of surfaces comprising surfaces comprised by tire 420 and surfaces comprised by wheel 410. Internal cavity 430 is defined by a set of surfaces comprised by tire 420 comprising an annular interior surface 424 opposite the tread surface 426, and a first sidewall internal surface 425 opposite first sidewall surface 427, and by a set of surfaces comprised by wheel 410, wheel rim surface 413. The annular interior surface 424 loops around the tire fully and therefore has a circumference, defines an interior surface circumferential direction 1302 along the annular interior surface in the direction of the circumference, defines an interior surface meridinal direction 464 tangent to the annular interior surface 424 and perpendicular to the interior surface circumferential direction 1302, and defines an interior surface normal direction 466 mutually perpendicular both to the interior surface circumferential direction 1302 and to the interior surface meridinal direction 464. The annular interior surface 424 may be adapted for engagement to a wheel 410. The annular interior surface 424 may be engaged with wheel rim surface 413 indirectly by first sidewall surface 427 and by second tire sidewall 428.

The tire circumferential direction 1304 coincides with interior surface circumferential direction 1302. In order to avoid repetition, unless otherwise noted herein, references to the interior surface circumferential direction 1302 also apply to the tire circumferential direction 1304. Similarly, the tire radial direction 474 coincides with interior surface normal direction 466. In order to avoid repetition, unless otherwise noted herein, references to the interior surface normal direction 466 also apply to the tire radial direction 474. In general, the interior surface meridinal direction 464 does not necessarily coincide with the tire axial direction 472 because the former is defined in part by the tangent to the annular interior surface 424, which may be curved, and the latter is defined by the axis of operational rotation 402, which is straight. It should be noted that in regions where the annular interior surface 424 is planar and parallel to the axis of operational rotation 402, such as may occur when the annular interior surface 424 passes through the tire footprint, the interior surface meridinal direction 464 may coincide with the tire axial direction 472.

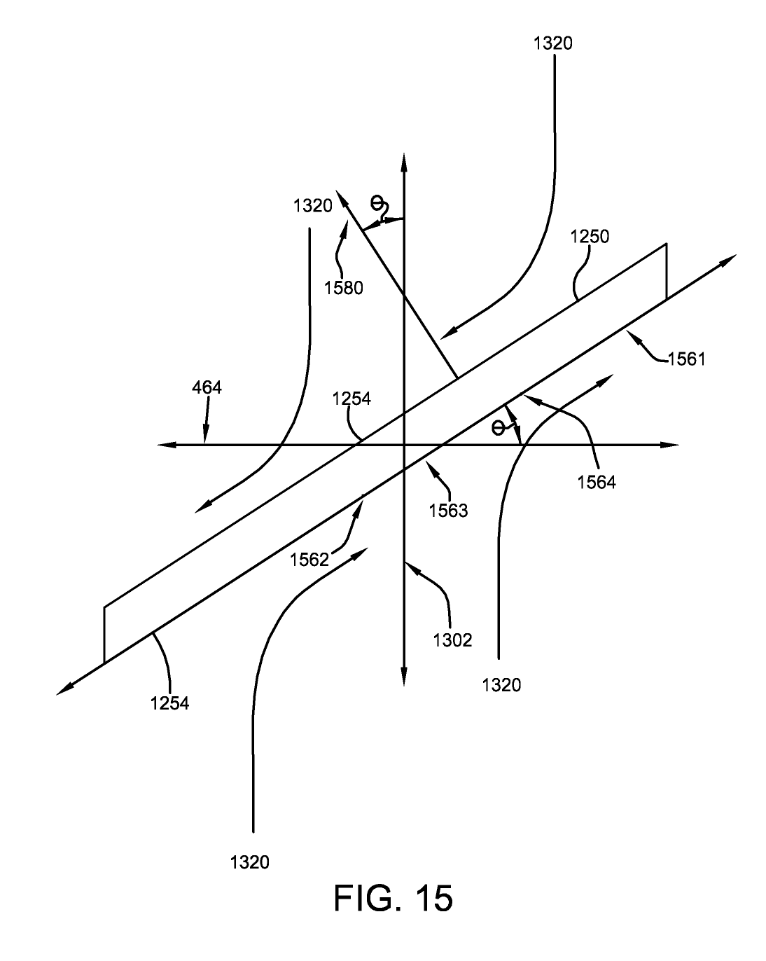

The above-described directions, may be used to define two different coordinate systems each usable for describing other directions. A first coordinate system may be defined comprising the mutually independent directions of the interior surface circumferential direction 1302, the interior surface normal direction 466, and the interior surface meridinal direction 464. A second coordinate system may be defined comprising the mutually independent directions of the tire circumferential direction 1304, the tire radial direction 474, and the tire axial direction 472. Using either the first coordinate system or the second coordinate system, an arbitrary direction may be defined therein in terms of vector sums of the vectors defined along the coordinate axes. Since the magnitude of an arbitrary direction is irrelevant, the magnitude of the vectors defined along the coordinate axes are also irrelevant and all may be assumed to be unitary without loss of generality. Referring now to FIG. 15, for example, and without limitation, the air flow feature surface 1254 extends from the annular interior surface 424 and also extends in the interior surface circumferential direction 1302 and in the interior surface meridinal direction 464. A unit vector 1580 normal to air flow feature surface 1254 would, because surface 1250 is at an angle θ with respect to interior surface meridinal direction 464 and by similar triangles, be at an angle θ with respect to the interior surface circumferential direction 1302, such that unit vector normal to air flow feature surface 1254 would have a component in the interior surface meridinal direction 464 of sine θ, a component in the interior surface circumferential direction 1302 of cosine θ, and having no component in the interior surface normal direction 466. Referring now to FIG. 14, for example, and without limitation, the air flow feature surface 1454 extends from the annular interior surface 424 and, at point 1464, extends in the interior surface circumferential direction 1302 and in the interior surface meridinal direction 464. A unit vector 1480 normal to air flow feature surface 1454 at point 1464 would because tangent plane 1463 is at an angle θ″ with respect to interior surface meridinal direction 464 and by similar triangles, be at an angle θ″ with respect to the interior surface circumferential direction 1302, such that unit vector normal to air flow feature surface 1454 at point 1464 would have a component in the interior surface meridinal direction 464 of sine θ″, a component in the interior surface circumferential direction 1302 of cosine θ″, and having no component in the interior surface normal direction 466.

In operation, tire-wheel system 400 will rotate and thereby roll or slide along a roadway (not shown). Also, during operation it is common for a tire-wheel system 400 to operate under some kind of load. The load may be a vehicle load, such as, some fraction of the weight of a vehicle, or it may be some other load, including but not limited to, a cargo load, a dynamic load, or the weight of tire-wheel system 400. A load will result in deformation of the tire region contacting the roadway into a tire footprint 1110 as shown in FIGS. 1 and 3. During operation, the individual elements comprising tire wheel system 400 will undergo rotation at a common rate such that any given element will have substantially the same angular velocity as every other element.

Inflation air 431 of a rotating pneumatic tire-wheel system 400 will tend to rotate along with a neighboring mass 431, 425, 424, 413. A neighboring mass 431, 425, 424, 413 may comprise annular interior surface 424, wheel rim surface 413, sidewall internal surface 425, or another quantity or fraction of the inflation air 431. In pneumatic tire-wheel system 400, the internal cavity 430 is bounded radially by annular interior surface 424, defining an outer radial limit, and wheel rim surface 413, defining a smaller inner radial limit. As noted above, during operation the annular interior surface 424 and the wheel rim surface 413 will rotate at substantially the same angular velocity. Since the annular interior surface 424 and the wheel rim surface 413 will rotate at substantially the same angular velocity but differ in their distance from the axis of rotation 402, the velocity at which they are moving differ from one another with the annular interior surface 424 being the faster. As noted above, the portion of the inflation air 431 closest to the annular interior surface 424 will tend to move at a rate along with the annular interior surface 424, while the portion of the inflation air 431 closest to the wheel rim surface 413 will tend to move at a rate along with the wheel rim surface 413, so that the portion of the inflation air 431 closest to the annular interior surface 424 will tend to move faster than the portion of the inflation air 431 closest to the wheel rim surface 413. This trend is generally borne out by the computational fluid dynamics results 110 shown in FIGS. 1-3. This trend is shown graphically in FIG. 8.

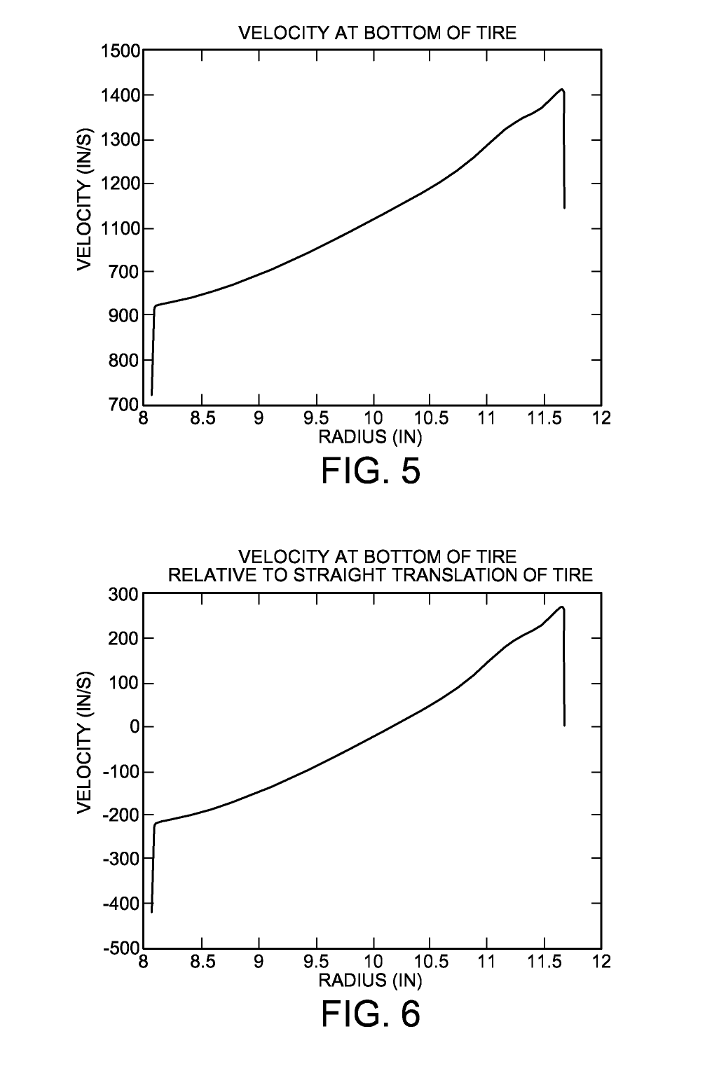

During operation, once per rotation any given section of the tire 420 will pass through the tire footprint 1110. As any given section of the tire 420 passes through the tire footprint 1110, the inflation air 431 contained in that section of the tire will also pass through the tire footprint 1110. A cross-section of the tire at or proximate to the tire footprint 1110 has a smaller area than a cross-section of the tire distal from the tire footprint. As a given section of the tire 420 passes through the tire footprint 1110 the cross-sectional area of that section is diminished, while the inflation air 431 contained in that section of the tire is passing therethrough. Because of the diminished area in the tire footprint 1110, the inflation air 431 contained in that section of the tire must flow more quickly relative to air flow 1320 elsewhere in internal cavity 430 in order to satisfy the relevant conservation requirements. This trend is generally borne out by the computational fluid dynamics results 110 shown in FIGS. 1-3. This trend is shown graphically in FIG. 5.

Referring now to FIGS. 4, and 12-15, a tire 420 or a wheel 410 may comprise an air flow feature 450, 1250, 1350, 1450. An air flow feature 450, 1250, 1350, 1450 is adapted to direct an air flow 1320 of inflation air 431 that impinges thereupon in some direction. An air flow feature 450, 1250, 1350, 1450 may comprise an air flow feature surface 454, 1254, 1354, 1454. An air flow feature 450, 1250, 1350, 1450 may be adapted for engagement with a surface of a tire 420 or a wheel 410 that, if assembled into a tire-wheel system 400, would at least partially define an internal cavity 430. A surface of a tire 420 or a wheel 410 that, if assembled into a tire-wheel system 400, would at least partially define an internal cavity 430 may comprise annular interior surface 424, wheel rim surface 413, sidewall internal surface 425, or a sidewall internal surface 429 opposite second tire sidewall 428.

An air flow feature 450, 1250, 1350, 1450 may be engaged with a surface of the tire 420 or a surface of the wheel 410 by an adhesive, a mechanical fastener, a molding operation, or by being integrally formed therewith. An adhesive may comprise polyvinyl acetate, polyurethane, polyethylene, epoxy, cyanoacrylate, or other adhesive chosen with good engineering judgment. A mechanical fastener may comprise a screw, a bolt, a nut, a clip, a clamp, a pin, a staple, a rivet, or other mechanical fastener chosen with good engineering judgment. A molding operation may comprise a tire molding operation, an injection molding operation, or other molding operation chosen with good engineering judgment. Components that are integrally formed are not formed as separate pieces, but rather are formed already joined as a single unitary piece. A non-limiting example of components that are integrally formed would be an embodiment in which an air flow feature 450, 1250, 1350, 1450 was formed with a carcass component (not shown) by extruding an overly thick carcass component (not shown) and milling away surrounding material until the air flow feature 450, 1250, 1350, 1450 was left as an integrally formed component with the carcass component (not shown). In some embodiments, an air flow feature 450, 1250, 1350, 1450 may be an integrally formed component of a surface of a tire 420 or a wheel 410 that, if assembled into a tire-wheel system 400, would at least partially define an internal cavity 430.

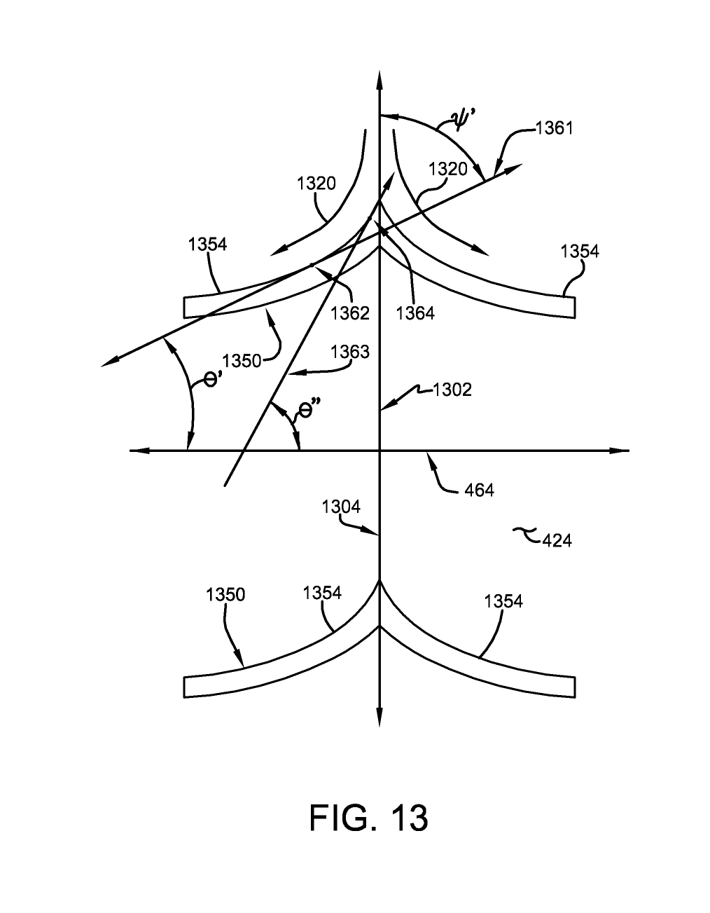

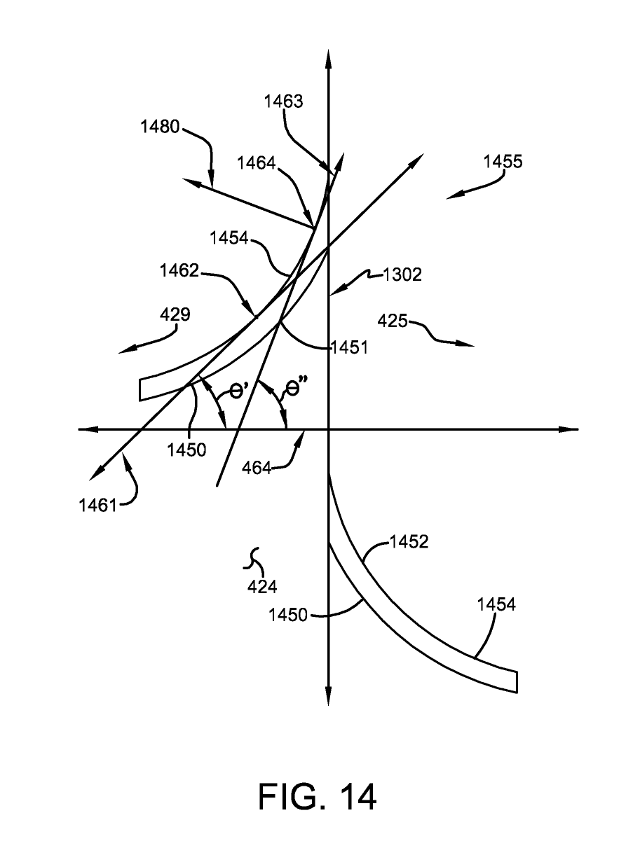

As shown in FIGS. 13 and 14, in some, non-limiting embodiments, a tire 420 may comprise one or more air flow features 450, 1250, 1350, 1450. In some embodiments a tire 420 may comprise a plurality of air flow features 450, 1250, 1350, 1450 engaged with annular interior surface 424, wheel rim surface 413, sidewall internal surface 425, or a sidewall internal surface 429 opposite second tire sidewall 428. In the non-limiting embodiments shown in FIGS. 13 and 14, tire 420 comprises a plurality of air flow features 1350, 1450 engaged with annular interior surface 424 in which the plurality of air flow features 1350, 1450 comprises at least two air flow features 1350, 1450 spaced circumferentially around the annular interior surface 424. In the embodiment shown in FIG. 14, tire 420 comprises a plurality of air flow features 1450 engaged with annular interior surface 424 in which the plurality of air flow features 1450 comprises at least two air flow features 1450 spaced along the interior surface meridinal direction 464. The embodiment shown in FIG. 14, shows one section of the annular interior surface 424 of a tire 420 in which a first air flow feature 1451 is positioned adjacent to or proximate to the sidewall internal surface 429, and a second air flow feature 1452 is positioned adjacent to or proximate to the sidewall internal surface 425, such that first air flow feature 1451 and second air flow feature 1452 together comprise a set of alternating air flow features 1455. The embodiment shown in FIG. 14 may further comprise additional sets of alternating air flow features 1455 spaced circumferentially around the annular interior surface 424. In some embodiments, a tire 420 comprises a plurality of air flow features 450, 1250, 1350, 1450 engaged with annular interior surface 424 in which the plurality of air flow features 450, 1250, 1350, 1450 comprises at least three air flow features 450, 1250, 1350, 1450 spaced circumferentially, evenly or otherwise, around the annular interior surface 424. In some embodiments, a wheel 410 comprises a plurality of air flow features 450, 1250, 1350, 1450 engaged with an annular exterior surface, such as, wheel rim surface 413, in which the plurality of air flow features 450, 1250, 1350, 1450 comprise at least three air flow features 450, 1250, 1350, 1450 spaced circumferentially, evenly or otherwise, around the annular exterior surface.

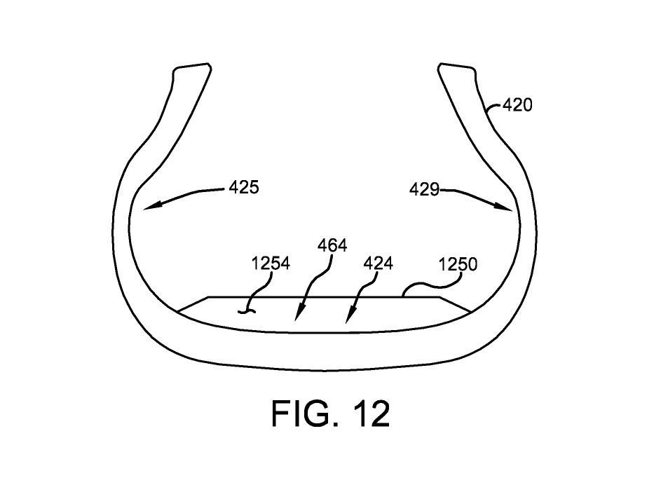

Referring now to FIGS. 4 and 12-15, an air flow feature 450, 1250, 1350, 1450 may comprise an air flow feature surface 454, 1254, 1354, 1454 that may comprise at least a portion thereof that extends in both the interior surface normal direction 466 and the interior surface meridinal direction 464. The air flow feature surface 454, 1254, 1354, 1454 shown in FIGS. 4 and 12-15, may also be said to comprise at least a portion thereof that extends in both the tire radial direction 474 and the tire axial direction 472. FIGS. 4 and 12 show air flow feature 450, 1250 comprising air flow feature surfaces 454, 1254 that extend in both the interior surface normal direction 466 and the interior surface meridinal direction 464. In FIGS. 4 and 12, since the view-plane at the sectional plane is perpendicular to the interior surface circumferential direction 1302, the interior surface circumferential direction 1302 is out of the page and is not visible. The result is the degree, if any, to which air flow feature surface 454 and 1254 may extend in the interior surface circumferential direction 1302 is not clear from the view in FIGS. 4 and 12. As will be made clear herebelow, air flow feature surface 1254 extends in the interior surface circumferential direction 1302. The air flow feature surface 1254 may also be said to extend in the tire circumferential direction 1304. FIGS. 13-15 show air flow feature 1250, 1350, 1450 comprising air flow feature surfaces 1254, 1354, 1454 that extend in both the interior surface circumferential direction 1302 and the interior surface meridinal direction 464. In FIGS. 13-15, since the view-plane is perpendicular to the interior surface normal direction 466, the interior surface circumferential direction 1302 is visible but the interior surface normal direction 466 is out of the page and is not visible. FIG. 15 shows another view of the embodiment shown in FIG. 12 such that the embodiment shown in FIGS. 12 and 15 comprises an air flow feature surface 1254 which extends in the interior surface normal direction 466, the interior surface meridinal direction 464, and the interior surface circumferential direction 1302. The embodiment shown in FIGS. 12 and 15 may also be said to comprise an air flow feature surface 1254 which extends in the tire radial direction 474, tire axial direction 472, and the tire circumferential direction 1304. In some embodiments, the extension in a given direction may be less than a millimeter, between 1 millimeter and 10 millimeters inclusive, or more than 10 millimeters. In some embodiments, an air flow feature surface 454, 1254, 1354, 1454 may extend more than 2 millimeters in the interior surface normal direction 466.

Referring now to FIGS. 4 and 12-15, an air flow feature 450, 1250, 1350, 1450 may comprise an air flow feature surface 454, 1254, 1354, 1454 having a plane of tangency 1361, 1461, 1561, 1363, 1463, 1563. A plane of tangency 1361, 1461, 1561, 1363, 1463, 1563 of an air flow feature surface 454, 1254, 1354, 1454 may form an angle θ with respect to the interior surface meridinal direction 464, or an angle φ with respect to the interior surface normal direction 466, or an angle ψ with respect to the interior surface circumferential direction 1302, or some combination thereof. If the air flow feature surface 1254 is substantially planar, than the plane of tangency 1561, 1563 of an air flow feature surface 1254 may form an angle θ, φ, ψ that is substantially constant with respect to the related direction no matter what point on the air flow feature surface 1254 is selected to which to be tangent. On the other hand, if the air flow feature surface 1354, 1454 is substantially curved, then the plane of tangency 1361, 1461 of an air flow feature surface 1354, 1454 may form an angle θ, φ, ψ that varies with respect to the related direction depending upon what point on the air flow feature surface 1354, 1454 is selected to which to be tangent. As shown in FIG. 15, an air flow feature 1250 may comprise an air flow feature surface 1254 that is substantially planar such that a first plane of tangency 1561 tangent to air flow feature surface 1254 at a first point 1562 on air flow feature surface 1254 will substantially coincide with a second plane of tangency 1563 tangent to air flow feature surface 1254 at a second point 1564 on air flow feature surface 1254 such that first plane of tangency 1561 and second plane of tangency 1563 will form substantially the same angle θ with respect to the interior surface meridinal direction 464. As shown in FIGS. 13 and 14, an air flow feature 1350, 1450 may comprise an air flow feature surface 1354, 1454 that is a substantially non-planar curved surface such that a first plane of tangency 1361, 1461 tangent to air flow feature surface 1354, 1454 at a first point 1362, 1462 on air flow feature surface 1354, 1454 may be substantially different from and may not substantially coincide with a second plane of tangency 1363, 1463 tangent to air flow feature surface 1354, 1454 at a second point 1364, 1464 on air flow feature surface 1354, 1454 such that first plane of tangency 1361, 1461 will form a first angle θ′ with respect to the interior surface meridinal direction 464 and the second plane of tangency 1363, 1463 will form a second angle θ″ with respect to the interior surface meridinal direction 464 where a first angle θ′ and second angle θ″ are substantially different. Angle θ may range from −90 to 90 degrees. Angle φ may range from −90 to 90 degrees. Angle ψ may range from −90 to 90 degrees. In some embodiments, an air flow feature surface 454, 1254, 1354, 1454 may have a plane of tangency 1361, 1461, 1561, 1363, 1463, 1563 at an angle θ with respect to the interior surface meridinal direction 464 such that angle θ is 10 degrees or more. In some embodiments, an air flow feature surface 454, 1254, 1354, 1454 may have a plane of tangency 1361, 1461, 1561, 1363, 1463, 1563 at an angle with respect to the axial direction 472 of 10 degrees or more.

As noted above, an air flow feature 450, 1250, 1350, 1450 is adapted to direct an air flow 1320 of inflation air 431 that impinges thereupon in some direction. An air flow feature is adapted to function as an impeller, such that an air flow 1320 of inflation air 431 that impinges upon an air flow feature surface 454, 1254, 1354, 1454 thereof may re-directed along a direction that depends upon the geometry of the air flow feature surface 454, 1254, 1354, 1454. For example and not limitation, as shown in FIG. 13, the air flow feature surface 1354 is curved such that, in addition to extending out of the page in the interior surface normal direction 466, it also extends in the interior surface meridinal direction 464, and the interior surface circumferential direction 1302. Air flow 1320 is shown flowing from a direction that is primarily along the interior surface circumferential direction 1302, but the air flow 1320 is redirected by impingement upon air flow feature surface 1354 to flow in a direction that is primarily along the interior surface meridinal direction 464. Described in terms of the tire circumferential direction 1304, tire radial direction 474, and the tire axial direction 472, the air flow feature surface 1354 is curved such that, in addition to extending out of the page in the tire radial direction 474, it also extends in the tire axial direction 472, and the tire circumferential direction 1304. Air flow 1320 is shown flowing from a direction that is primarily along the tire circumferential direction 1304, but the air flow 1320 is redirected by impingement upon air flow feature surface 1354 to flow in a direction that is primarily along the tire axial direction 472. An air flow feature surface 454, 1254, 1354, 1454 may be adapted such that an air flow 1320 of inflation air 431 flowing along the interior surface circumferential direction 1302 that impinges upon air flow feature surface 454, 1254, 1354, 1454 may be re-directed along the interior surface normal direction 466 or primarily along the interior surface meridinal direction 464 or along a direction having a component along the interior surface normal direction 466, along the interior surface meridinal direction 464, along the interior surface circumferential direction 1302, or some combination thereof. Described in terms of the tire circumferential direction 1304, tire radial direction 474, and the tire axial direction 472, an air flow feature surface 454, 1254, 1354, 1454 may be adapted such that an air flow 1320 of inflation air 431 flowing along the tire circumferential direction 1304 that impinges upon air flow feature surface 454, 1254, 1354, 1454 may be re-directed along the tire radial direction 474 or primarily along the tire axial direction 472, or along a direction having a component along the tire radial direction 474, along the tire axial direction 472, along tire circumferential direction 1304, or some combination thereof.

Referring now to FIGS. 5-10 shown are a series of graphs describing computational fluid dynamics calculated air flow velocity inside a tire-wheel system as a function of variables comprising radial position using assumptions identical to those used in calculating the computational fluid dynamics results 110 shown in FIGS. 1-3. Graph 5 shows air flow velocity near the footprint as a function of radial position. Graph 6 shows air flow velocity near the footprint relative to straight translation with the tire tread as a function of radial position in a tire-wheel system with an air flow feature 450, 1250, 1350, 1450 mounted to an annular interior tire surface 424 proximate to the tire crown. Graph 7 shows air flow velocity near the footprint relative to rigid rotation with the wheel as a function of radial position in a tire-wheel system with an air flow feature 450, 1250, 1350, 1450 mounted to an annular exterior surface, such as wheel rim surface 413. Graph 8 shows air flow velocity near the top of the tire as a function of radial position in a tire-wheel system. As noted above, the computational fluid dynamics results 110 project that the flow along inner radius 13 is approximately 715 inches per second while the flow along outer radius 137 is approximately 1142 inches per second. Accordingly, the computational fluid dynamics results in FIG. 8 show that in regions distal from the footprint, the air velocity is slightly less than the neighboring mass. Graph 9 shows air flow velocity near the top of the tire relative to rigid rotation with the tire as a function of radial position in a tire-wheel system with an air flow feature 450, 1250, 1350, 1450 mounted to an annular interior tire surface 424 proximate to the tire crown. Graph 10 shows air flow velocity near the top of the tire relative to rigid rotation with the wheel as a function of radial position in a tire-wheel system with an air flow feature 450, 1250, 1350, 1450 mounted to an annular exterior surface, such as wheel rim surface 413.

In general modifying the flow of inflation air 431 within an internal cavity 430 may help to promote turbulent air flow within the internal cavity 430 which may, in turn, promote heat exchange between the footprint of the tire 420 and the surrounding environment 440. Promoting flow of inflation air 431 within an internal cavity 430 along tire radial direction 474 or along the interior surface normal direction 466 may help to promote heat exchange between the footprint of the tire 420 and the surrounding environment 440.

While the tire cavity air flow feature has been described above in connection with certain embodiments, it is to be understood that other embodiments may be used or modifications and additions may be made to the described embodiments for performing the same function of the tire cavity air flow feature without deviating therefrom. Further, the tire cavity air flow feature may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the tire cavity air flow feature. Therefore, the tire cavity air flow feature should not be limited to any single embodiment, but rather construed in breadth and scope in accordance with the recitation of the attached claims.

What is claimed is:

1-15. (canceled)

16. A pneumatic tire adapted for inflation with inflation air, said pneumatic tire comprising:
(A) an axis of operational rotation about which the pneumatic tire rotates when operated;
(B) an annular interior surface, said annular interior surface having a circumference, said annular interior surface,
(1) being adapted for engagement with a wheel,
(2) looping fully around the pneumatic tire and positioned radially outward from the axis of operational rotation,
(3) defining a portion of an internal cavity that holds inflation air,
(4) defining an interior surface circumferential direction that is along the annular interior surface, perpendicular to a radial axis that intersects the axis of operational rotation and the annular interior surface, and, perpendicular to the axis of operational rotation,
(5) defining an interior surface meridinal direction tangent to the annular interior surface, parallel to the axis of operational rotation and perpendicular to the interior surface circumferential direction, and
(6) defining an interior surface normal direction mutually perpendicular both to the interior surface circumferential direction and to the interior surface meridinal direction; and
(C) one or more air flow features, said one or more air flow features
(1) engaged with said annular interior surface,
(2) adapted to direct a flow of the inflation air into a non-interior surface circumferential direction, and
(3) comprising an air flow feature surface, said air flow feature surface,
(a) comprising at least a portion thereof that extends in both the interior surface normal direction and the interior surface meridinal direction, and
(b) extends more than 2 millimeters in the interior surface normal direction, or
(c) extends in the interior surface circumferential direction.

17. The pneumatic tire of claim 16, wherein said one or more air flow features comprises a plurality of air flow features.

18. The pneumatic tire of claim 17, wherein each of said plurality of air flow features is engaged with said annular interior surface by an adhesive, a mechanical fastener, a molding operation, or by being integrally formed therewith.

19. The pneumatic tire of claim 18, wherein said plurality of air flow features comprise at least three air flow features spaced circumferentially around the annular interior surface.

20. The pneumatic tire of claim 19, wherein said plurality of air flow features are integrally formed components of said annular interior surface of said pneumatic tire.

21. The pneumatic tire of claim 20, wherein at least one of said plurality of air flow features comprises an air flow feature surface that comprises at least a portion thereof that extends in the interior surface normal direction, the interior surface meridinal direction, and the interior surface circumferential direction.

22. The pneumatic tire of claim 20, wherein at least one of said plurality of air flow features comprises an air flow feature surface that extends more than 2 millimeters in the interior surface normal direction.

23. The pneumatic tire of claim 20, wherein at least one of said plurality of air flow features comprises an air flow feature surface having a plane of tangency at an angle with respect to the interior surface meridinal direction of 10 degrees or more.

24. The pneumatic tire of claim 21, wherein
at least one of said plurality of air flow features comprises an air flow feature surface that extends more than 2 millimeters in the interior surface normal direction; and
at least one of said plurality of air flow features comprises an air flow feature surface having a plane of tangency at an angle with respect to the interior surface meridinal direction of 10 degrees or more.

25. A tire-wheel system comprising:
(A) a wheel comprising,
(1) a wheel axis of operational rotation about which the wheel rotates when operated,
(2) a rim portion, said rim portion comprising an annular exterior surface, said annular exterior surface having a circumference, said annular exterior surface,
(a) looping fully around the wheel and positioned radially outward from the wheel axis of operational rotation,
(b) defining a portion of an internal cavity that holds inflation air,
(c) defining a wheel circumferential direction that is along the annular exterior surface, perpendicular to a radial axis that intersects the axis of operational rotation and the annular exterior surface, and, perpendicular to the wheel axis of operational rotation,
(3) said rim portion being adapted for engagement with a pneumatic tire;
(B) said pneumatic tire adapted for inflation with the inflation air, said pneumatic tire comprising,
(1) a tire axis of operational rotation about which the pneumatic tire rotates when operated and defining a tire axial direction,
(2) an annular interior surface, said annular interior surface
(a) being adapted for engagement with the rim portion of said wheel,
(b) looping fully around the pneumatic tire and positioned radially outward from the tire axis of operational rotation,
(c) defining a portion of the internal cavity that holds the inflation air,
(d) having a circumference,
(e) defining a tire circumferential direction that is along the annular interior surface, perpendicular to a radial axis that intersects the tire axis of operational rotation and the annular interior surface, and, perpendicular to the tire axis of operational rotation,
and
(3) a tire radial direction mutually perpendicular to both the tire axial direction and the tire circumferential direction; and
(C) one or more air flow features, said one or more air flow features
(1) engaged with
(a) said annular interior surface of said pneumatic tire, or
(b) said annular exterior surface of said rim portion, and
(2) comprising an air flow feature surface, adapted to direct a flow of said inflation air into a direction having a component along the tire radial direction and the tire axial direction, said air flow feature surface,
(a) comprising at least a portion thereof that extends in the tire radial direction and the tire axial direction, and
(b) extends more than 2 millimeters in the tire radial direction, or extends in tire circumferential direction.

26. The tire-wheel system of claim 25, wherein said one or more air flow features comprises a plurality of air flow features.

27. The tire-wheel system of claim 26, wherein each of said plurality of air flow features are engaged with said annular interior surface of said pneumatic tire.

28. The tire-wheel system of claim 27, wherein said plurality of air flow features comprise at least three air flow features spaced substantially evenly around the annular interior surface.

29. The tire-wheel system of claim 28, wherein said plurality of air flow features are integrally formed components of said annular interior surface of said pneumatic tire.

30. The tire-wheel system of claim 29, wherein at least one of said plurality of air flow features comprises an air flow feature surface that comprises at least a portion thereof that extends in the tire radial direction, the tire axial direction, and the tire circumferential direction.

31. The tire-wheel system of claim 30, wherein at least one of said plurality of air flow features comprises an air flow feature surface that extends more than 2 millimeters in the tire radial direction.

32. The tire-wheel system of claim 31, wherein at least one of said plurality of air flow features comprises an air flow feature surface that has a plane of tangency having an angle with respect to the tire axial direction of 10 degrees or more.

33. The tire-wheel system of claim 26, wherein each of said plurality of air flow features are engaged with said annular exterior surface of said rim portion.

34. The tire-wheel system of claim 33, wherein said plurality of air flow features comprise at least three air flow features spaced substantially evenly around the annular exterior surface.

35. A pneumatic tire adapted for inflation with inflation air, said pneumatic tire comprising:
(A) an axis of operational rotation about which the pneumatic tire rotates when operated;
(B) an annular interior surface, said annular interior surface having a circumference, said annular interior surface,
(1) being adapted for engagement with a wheel,
(2) looping fully around the pneumatic tire and positioned radially outward from the axis of operational rotation,
(3) defining a portion of an internal cavity that holds the inflation air,
(4) defining an interior surface circumferential direction that is along the annular interior surface, perpendicular to a radial axis that intersects the axis of operational rotation and the annular interior surface, and, perpendicular to the axis of operational rotation,
(5) defining an interior surface meridinal direction tangent to the annular interior surface, parallel to the axis of operational rotation and perpendicular to the interior surface circumferential direction, and
(6) defining an interior surface normal direction mutually perpendicular both to the interior surface circumferential direction and to the interior surface meridinal direction; and
(C) a plurality of air flow features,
(1) wherein each of said plurality of air flow features is an integrally formed component of said annular interior surface,
(2) wherein said plurality of air flow features comprise at least three air flow features spaced circumferentially around the annular interior surface,
(3) wherein each of said plurality of air flow features is adapted to direct a flow of the inflation air into a non-interior surface circumferential direction,
(4) wherein at least one of said plurality of air flow features comprises an air flow feature surface that comprises at least a portion thereof that extends in
(a) the interior surface normal direction,
(b) the interior surface meridinal direction, and
(c) the interior surface circumferential direction,
(5) wherein at least one of said plurality of air flow features comprises an air flow feature surface that extends more than 2 millimeters in the interior surface normal direction, and
(6) wherein at least one of said plurality of air flow features comprises an air flow feature surface having a plane of tangency at an angle with respect to the interior surface meridinal direction of 10 degrees or more.
